(19) United States
(12) Patent Application Publication
(10) Pub. No.: US 2002/0033853 A1
(43) Pub. Date: Mar. 21, 2002

(54) Printing device and roll paper

(76) Inventor: Shuichi Aratsu, Tokyo (JP)

Correspondence Address: Charles N. Quinn, Esq., Saul Ewing LLP, Centre Square West, 1500 Market Street, 38th Floor, Philadelphia, PA, 19102, US

(21) Appl. No.: 09/820,280

(22) Filed: Mar. 28, 2001

Related U.S. Application Data
(63) Continuation of application No. 09/298,877, filed on Apr. 26, 1999, now abandoned.

(51) Int. Cl. B41J 29/38; B41J 2/01; G01D 15/24

(52) U.S. Cl. 347/16; 347/101; 346/136

(57) ABSTRACT

To provide a printing device capable of automatically detecting the type of the roll paper, the printing device comprises a movable flange abutting member adapted to be pressed against an outer periphery of said flange of the holder of the paper roll supported in said paper roll support mechanism, said flange having an outer diameter set in correspondence with the type of said roll paper; a detection unit of paper type adapted to be subjected to positioning by said outer periphery of the flange for detecting said type of the roll paper; a detection unit of paper presence/absence provided at a printing portion in facing relation to said platen to detect the presence of said roll paper without contact thereto; a detection unit for detecting the leading end of said roll paper arranged between said printing portion and: a cutting portion to be subjected to a printing operation; and control means for controlling actions of the relevant portions on the basis of the detection result of each detection unit.

### BACKGROUND OF THE INVENTION

This invention relates to a printing device like an ink jet printer for ejecting ink onto roll paper for printing. More specifically, this invention relates to a printing device for detecting type of roll paper loaded, the presence or absence of the roll paper, the leading end of the roll paper, and a preferable roll paper to be used in a printing device.

### PRIOR ART

Nowadays, it has become possible for everybody to easily perform image printings thanks to the progress of computers and printing devices. Among the characteristic examples of printing devices is known an electrophotographic copier which causes a toner to adhere onto an electrostatic potential image formed on the paper roll and transcript the toner image onto the printing paper, a printing device which is called an ink jet printer of the aforementioned ink jet type or a printing device which is called a thermal transfer printer of a thermal transfer type which is adapted to melt the ink on the ink ribbon by means of a heated thermal head or cause the heat sensitive paper to be colored.

While color printing in general is required to have a good color tone quality and wheatherproofness, a wide application of printing media varing from paper, cloth, film or the like is seen and in order to maintain a printing quality in an excellent condition, the printing conditions are in general subjected to review on the basis of the type or property of a printing medium.

While it is possible to discriminate types of paper used through its factors such as surface roughness, light transparency and rigidity, but it is not practical to mount detection mechanism for that purpose upon printing device, because one detection device is necessary for anything of said paper factors, thus increasing considerably the cost of printing device. When detecting type of paper using the factor of light transparency, only three states of paper, i.e. transparent, translucent and opaque, which limits adaptation to more and more various types of paper. As described above, direct detection of paper type has been difficult in technical and economical view points.

In general, users of printing device have input the type of paper used into printing device by any means. One of these means has been setting of the type of paper on the operating panel of printing device by user. More recently, the information about type of paper to be used is often transferred into printing device from personal computer together with printing data. In the last case, user selects his desired type of paper from Paper Menu printed on a software called Printer Driver containing types of paper such as common paper, coat paper, film for a overhead projector (OHP), back print film, burnished paper and the like.

In addition, it is essential to set printing paper sheets neatly on the printing device. If not, it is not only impossible to maintain the printing quality but also likely to lead to the trouble in which the printing head can rub the printing face of the paper sheet or perform the printing action without the printing paper sheet being fed onto the platen with the result that the paper sheet is stained or the printing head and the platen are damaged to lead to the trouble of the printing device.

Therefore, it is required in general to refrain from performing a printing operation when the printing paper is not set properly or has run out.

In the case of a printing device which uses a long roll paper which necessitates a paper cut mechanism for cutting off the roll paper, it is often observed that an immediate start of the subsequent printing operation after the paper cutting operation to create an extra margin on the leading end of the paper sheet, which must be thrown away. This is not only a waste of paper but also another cutting operation must be done after the subsequent cutting of the roll paper, causing a duplication of work.

In such conventional method of using the roll paper, the roll paper payed out from the paper roll is fed in an opposite direction to the regular feed direction to reduce a margin space in the leading end of the paper as much as possible.

On the other hand, while there are several cases where one can easily discriminate paper used by means of appearance thereof and touch feeling thereon, there are so many papers which have resembling appearance and feeling. Therefore, users erroneously set different types of papers such as common paper and coat paper, both of which have same color at a glance, though they have quite different colors when reviewed carefully.

In case where the printing device is constructed such that it performs the printing operation by switching the printing conditions in accordance with the type of printing paper to be used, printing can be done on a condition other than suited for the paper if the operator makes an erroneous setting concerning the type of printing paper with the result that the printing quality desired by the operator cannot be obtained. Further, if the operator uses a printing device of the ink jet type which for example can perform a printing operation in not prescribed ink quantity for some type of printing paper. In this way, if setting is done on the basis of a wrong type of paper, extra ink used can adhere to some portions of the printing device to such an extent as thus staining the printing device or the printing paper.

Detecting devices used in a conventional printing device are known as a lever type, an optical type, etc.

In said lever type printing paper detect mechanism, the lever position varies depending upon the presence or absence of the printing paper and said varied lever position is detected as ON/Off signals of the switch. On the other hand, an optical type paper detection mechanism includes a reflection type in which a light irradiated by the light emitting portion onto the paper to be reflected thereby is detected by the light receiving portion and a transmission type in which a light transmitted is detected by a light receiving portion positioned opposite the light emitting portion.

In said optical paper detection mechanism of reflection type permits the variation of the intensity of reflection of the light irradiated by the light emitting portion on the basis of the presence or absence of the printing paper to be converted into the variation of the electrical output for detection. On the other hand, the optical paper detection mechanism of transmission type converts into the variation of electrical output the variation of intensity of light determined depending on whether or not to interrupt the light irradiated by the light emitting portion on the basis of the presence or absence of the printing paper.

In the conventional printing paper detect mechanism, it is possible to detect the presence or absence of the printing paper regardless of the light transmitting property whether transparent or opaque if the mechanism is of a lever type. However, such mechanism has a problem that it is necessary to bring the lever in contact with the platen by way of the printing paper in order to detect the presence or absence of the printing paper at the printing portion, causing the lever to contact the platen directly if there is no printing paper thereat with the result that the platen can be damaged. Therefore, an optical paper detect mechanism of reflection type is used in general as a paper detection mechanism.

Such optical paper detection mechanism of reflection type has another problem that it is impossible as is to detect the presence or absence of the printing paper if the paper is a light transmitting transparent sheet such as OHP paper. Then, a light reflecting opaque portion is formed at an end portion (said end portion taken in a direction perpendicular to the paper feed) of the transparent sheet so that said opaque portion reflects the light to be detected. However, such method also has a problem that the opaque portion at the end of the printing paper makes it impossible to effectively use the entire surface of the printing paper and makes the opaque portion too conspicuous to prevent the printed image from viewed easily when projected by an over head projector.

Further, excessive rewinding of the roll paper in the user's attempt at saving the paper or any possible misalignment of the leading end of the roll paper upstream of the correct position of printing portion can cause a printing action to be performed against the platen or cause a clogging of paper as a result of excessive rearward feed.

### SUMMARY OF THE INVENTION

In view of the above points, it is the object of the present invention to provide a printing device which is capable of automatically detecting the type of the roll paper.

It is another object of the present invention to provide a printing device which is capable of effectively detecting the presence and absence of the roll paper formed of a light transmitting transparent sheet by means of an optical printing paper detect mechanism and a roll paper which is detected in a favorable condition by the optical printing paper detection mechanism.

It is a further object of the present invention to provide a printing device which is capable of automatically detecting whether or not the leading end of the roll paper fed for the printing operation is positioned properly when the roll paper has been rewound in order to prevent an extra margin from being formed.

In order to achieve the aforementioned object, a printing device according to claim 1 is characterized by a holder engaging member which is movable and can be applied onto peripheral surface of the flange of said holders of said paper roll held by said paper roll holding mechanism, by a paper type detection unit for detecting type of said roll paper according to the position of said flange engaging correspondingly to outer diameter of said flange representing type of said roll paper used, by a paper presence/absence detection unit for detecting the presence or absence of said roll paper without contact therewith is located in said printing portion so as to oppose to said platen, by a paper leading end detection unit for detecting the leading end of said roll paper is located between said printing portion and a cutting portion, and control means for controlling actions of the relevant portions on the basis of the detection result of each detection unit.

In such a construction, said paper type detection unit can automatically detect type of paper only by amounting a flange, outer diameter of which is adapted to type of roll paper, said paper presence/absence detection unit can automatically detect the presence or absence of said roll paper without contact therewith, said paper leading end detection unit can automatically detect whether the paper leading end of said roll paper is in a appropreate position or not, and control means can control appropreate actions of the relevant portions on the basis of the detection result of each detection unit.

The printing device according to claim 2 is characterized in that the detecting unit of paper presence/absence is composed of a photosensor while the control means is constructed to determine the paper type by reversing information from the photo sensor on the basis of a result whether or not light transmission.

By adopting the aforementioned construction, the it is possible to automatically detect the presence/absence of the roll paper by means of the photosensor notwithstanding the result as to whether or not the roll paper is of light transmitting nature.

The roll paper according to claim 3 is characterized by being formed of a light transmitting transparent sheet and having a light reflector at the trailing end thereof.

By adopting the aforementioned construction, it is possible to effectively use the entire surface of the roll paper if said roll paper is formed of a light transmitting transparent sheet and said light reflector of the roll sheet is capable of automatically detecting the presence/absence of the paper.

### BRIEF DESCRIPTION OF THE DRAWINGS

FIG. 1 is a perspective view showing an embodiment of the printing device according to the invention;

FIG. 2 is a partial side view of the printing device shown in FIG. 1;

FIG. 3 is a plan view showing the roll holding mechanism shown in FIG. 1;

FIG. 4 is a front view of the paper roll used in the embodiments;

FIG. 5 is perspective views showing the paper roll used in the embodiments;

FIG. 6(A) is an enlarged perspective view of the paper type detection unit and FIG. 6(B) is a perspective view of the essential portion of FIG. 6(A); and

FIG. 7 is a control block diagram including the control means of the printing device shown in FIG. 1.

### DETAILED DESCRIPTION OF THE INVENTION

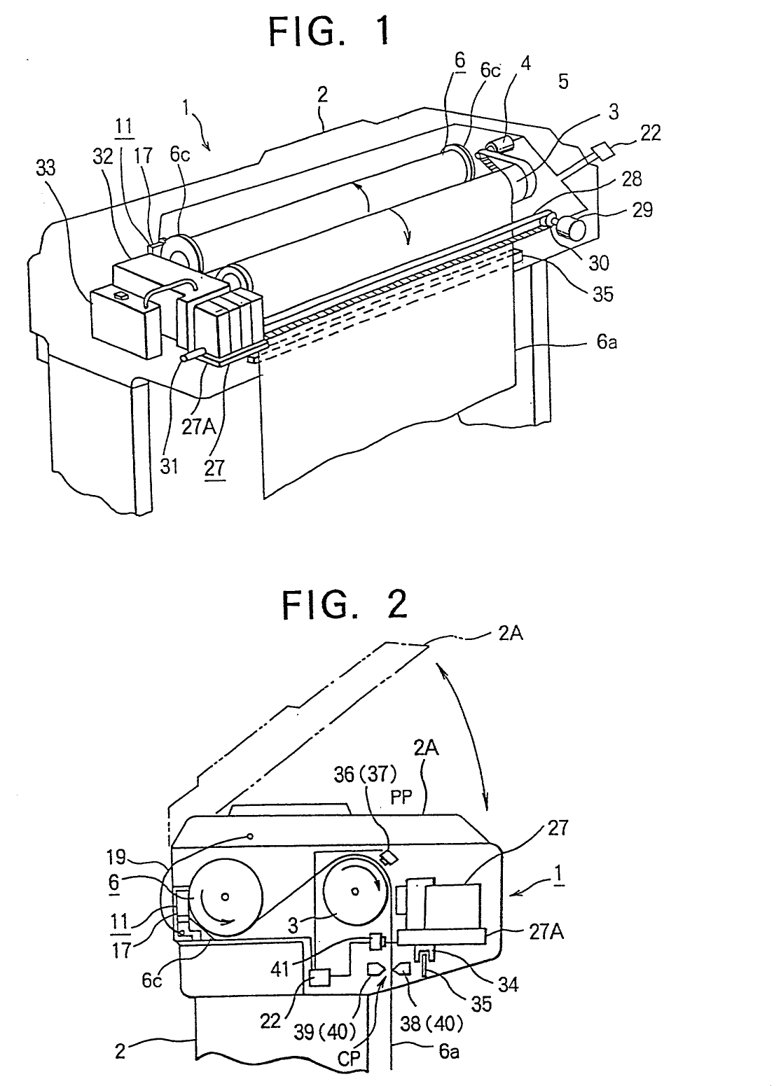

An embodiment of printing device 1 according to the present invention as shown in FIG. 1 and FIG. 2, has a housing 2, in which a cylindrical platen 3 is rotatably mounted with its axis extending in horizontal direction. Said surface of platen 3 can absorb light and is controlled not to reflect light such as a coarse surface to assure diffused reflection or blacked surface to absorb light. A driven pulley (not-shown) is supported by one end to said platen 3, a belt 5 driven by a first reversible motor 4 being wound on said driven pulley. Accordingly, said platen 3 can be driven by driving force of said first motor 4 in the normal transporting direction or in the reverse direction.

A paper roll 6 having an axis parallel to said platen 3 is mounted on the rear side of said platen 3 in said housing 2. A roll paper 6a to be explained later, being wound on the peripheral surface of said paper roll 6. When said paper roll 6 is rotated in counter-clockwise direction in FIG. 2, roll paper 6a to be used is released out of paper roll 6 to be wound on the upper side of said platen 3.

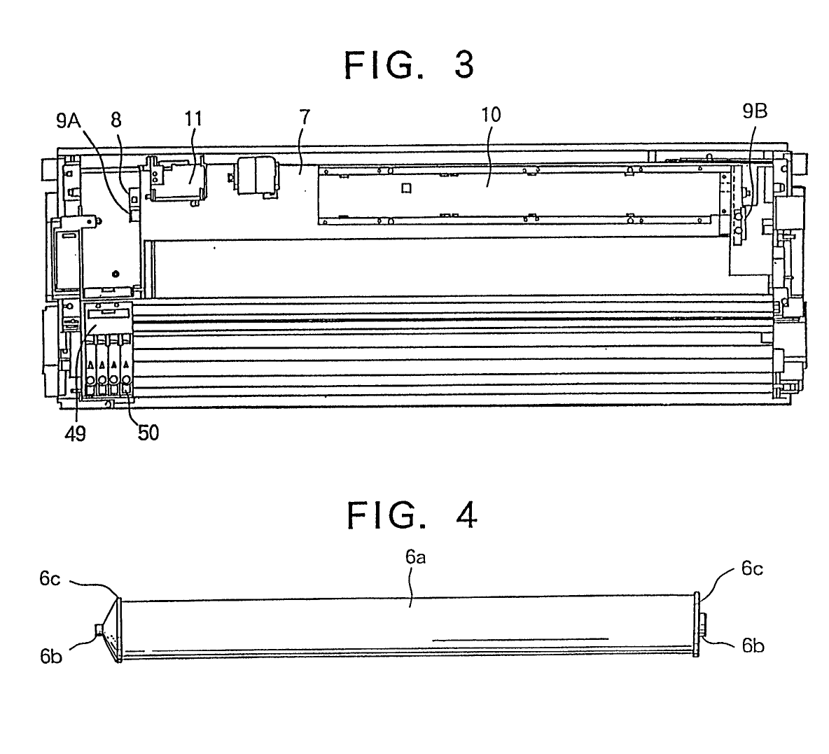

Said paper roll 6 is supported as shown in FIG. 3 on a pair of holding portions 9A and 9B of the paper roll holding mechanism over a base section 7 of the printing device 1 with a spacing therebetween in a longitudinal direction. Of said two members, the holding portion 9B is detachably loaded at a plurality of positions on a holding portion supporting plate 10 to fit the width of the roll paper 6a. Close to said holding portion 9A, a detection unit 11 of paper type for detecting the type of the roll paper 6a used as a printing paper.

As shown in FIG. 4, said paper roll 6 comprises said roll paper 6a wound on a paper tube (not-shown), said paper tube having paper tube holders 6b, 6b mounted on its both ends, and these paper tube holders being held respectively by said roll holders 9A, 9B. Said each paper tube holder 6b, 6b has round flange portion 6c having a diameter larger than that of roll paper 6a. According to the invention, the diameter of said flange portions 6c has different size according to the type of roll paper 6a wound on said paper tube, i.e. common paper, coat paper, film for OHP, back print film, burnished film and the like. Accordingly, one can identify the paper type according to the diameter of flanges 6c used.

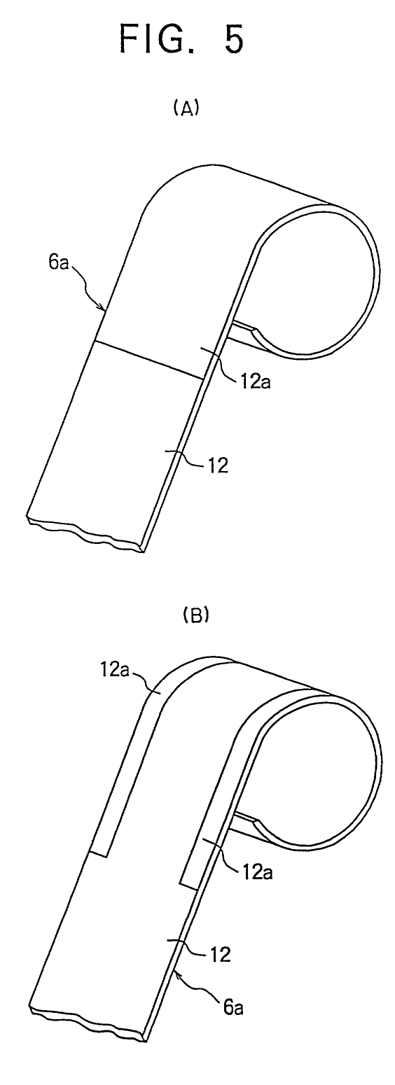

Further, in this embodiment, if the roll paper 6a is formed of a light transmitting transparent sheet 12 such as OHP paper, a light reflecting portion 12a is provided only at a trailing end of the light transmitting transparent sheet 12 as shown in FIG. 5(A). In this connection, the light reflecting portion 12a may be provided at opposite sides perpendicular to the longitudinal direction as shown in FIG. 5(B). So long as provided at the trailing end thereof, the structure is not limited to this embodiment.

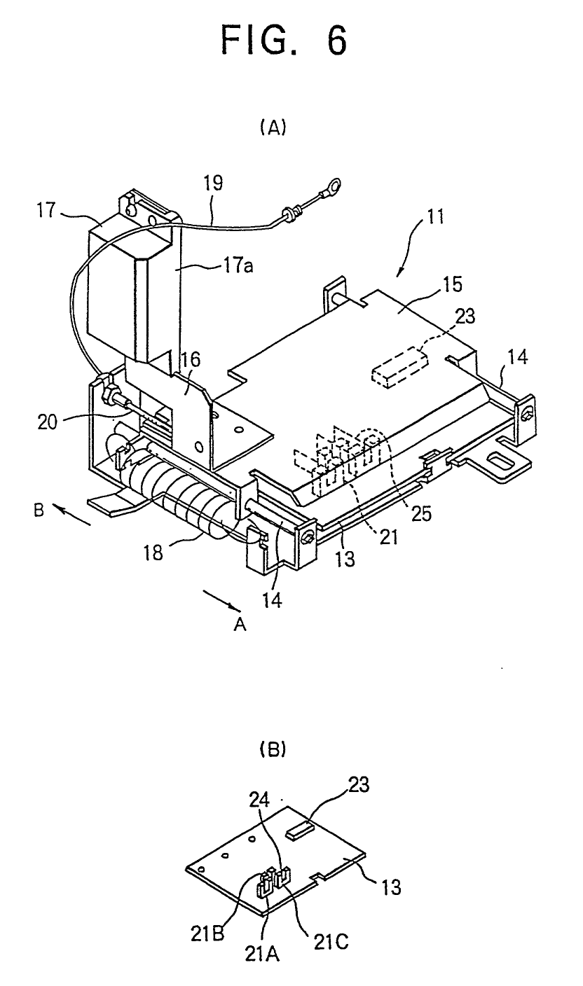

As shown in FIG. 6, said detection unit of paper type 11 for outputting detection signals for detecting type of said roll paper 6a has abase plate 13 located adjacent to one of said roll holders 9A. Said base plate 13 supports above it a pair of parallel guide rods 14, 14 which are parallel to each other and extend in horizontal direction so as to vertically cross the axis of said paper roll 6. A sliding table 15 is mounted on said guide rods 14, 14 so as to shift along the extending direction of said rods 14. A bracket 16 extends upwardly on the one end of said sliding table 15, and said bracket 16 supports thereon a flange abutting block member 17 having its one side surface 17a used as a flange abutting surface. A coil spring 18 is provided between said base plate 13 and said sliding table 15 so as to urges said sliding table 15 in the direction A shown in FIG. 6(A) for pressing said flange abutting member 17 onto said flange 6c of said paper roll 6.

One end of a wire 19 as a manipulating member is connected to said bracket 16. On the other hand, a hollow tube 20 is fixed on an edge portion of said base plate 13 so as to extend from the fixing point of said wire 19 on said bracket 16 in a reverse direction B to the urging direction A of said coil spring 18. Said wire 19 passes through said tube 20 and extends outside of said base plate 13, the other end of said wire 19 being fixed onto said cover 2A (FIG. 2). Consequently, when opening said cover 2A, said sliding table 15 is shifted by said wire 19 in the direction B against the urging force of said coil spring 18. Accordingly, when exchanging paper roll 6, said flange abutting member 17 as an example of roll holder abutting member is retracted into a retracted position. Further, when said cover 2A is closed, said wire 19 is relaxed and said sliding table 15 is pulled in the direction A due to the urging force of said coil spring 18.

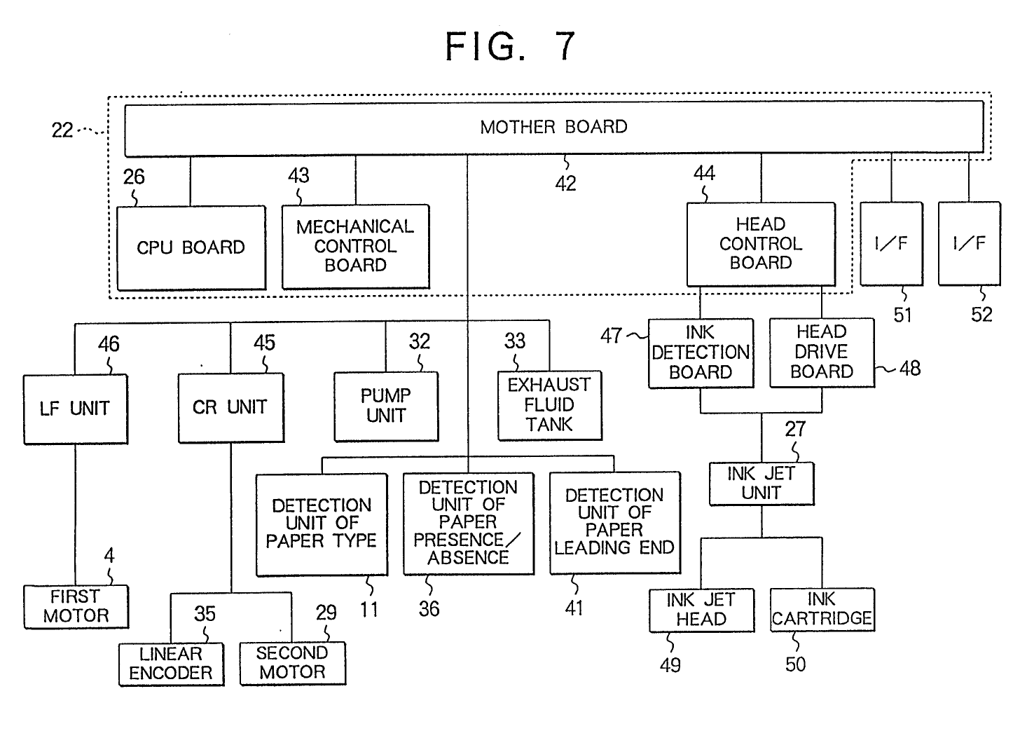

Three photosensors 21A, 21B, 21C and an output connector 23 for outputting signals from respective photosensors 21 to said controller 22 (FIG. 7) are located on said base plate 13. Said respective photosensors 21 have respectively a U-form, and three state setting sheets 25 having each plate form to be inserted into the hollow portions of corresponding photosensors 21 are supported on the rear side surface of said sliding table 15 so as to engage into respective photosensors 21. Each state setting sheet 25 is a shielding plate for shielding light from light emitting portion of each photosensor so as not to reach light receiving portion thereof, while said state setting sheet 25 has slits (not-shown) allowing light from light emitting portion thereof to reach light receiving portion thereof.

Each photosensor 21 has a construction such that it outputs signal ON when light from light emitting portion reaches light receiving portion, while it outputs signal OFF when light from light emitting portion does not reach light receiving portion. As a result, the position of sliding table 15 with respect to said base plate 13 is changed correspondingly to diameter of said flange 6c at the end of paper roll 6. Thus, each photosensor 21A, 21B, 21C outputs ON signal or OFF signal to said CPU board 26 (FIG. 7) according to the position of said slits of corresponding state setting sheet 25. On the other hand, said CPU of said CPU board 26 of the control means 22 can thus detect the type of paper (roll paper 6a) according to the flange diameter obtained by combination of ON or OFF signals issued from respective three photosenors 21 as shown in the following Table 1. The types of paper thus detected are output to said CPU board 26 and are displayed on a displaying panel (not-shown) of the device 1.

TABLE 1

| | Flange Diameter | | | |
|---|---|---|---|---|
| Paper Type | (mm) | Sensor A | Sensor B | Sensor C |
| No Paper | 0 | ON | ON | ON |
| 1 | 48-52 | OFF | ON | OFF |
| 2 | 58-62 | OFF | OFF | ON |
| 3 | 70-74 | ON | OFF | ON |
| 4 | 80-84 | OFF | ON | ON |
| 5 | 88-92 | ON | ON | OFF |
| 6 | 98-102 | ON | OFF | OFF |

Sensors A, B and C shown in this Table 1 designated respectively said photosensors 21A, 21B and 21C.

Said CPU board 26 can carry out image processing and driving of ink jet heads (not-shown) in Table 2 correspondingly to detected type of paper.

TABLE 2

| Paper Type | Image Processing | Paper Feeding | Ink Jet Head |
|---|---|---|---|
| 1 | Standard | Standard | Standard |
| 2 | Standard | Standard | Standard |
| 3 | Standard | Standard | Standard |
| 4 | Dedicated | Standard | Dedicated |
| | | | (Less Ink Ejecting) |
| 5 | Private | Dedicated | Standard |
| | | (Double Printing) | |
| 6 | Standard | Standard | Dedicated |
| | | | (Scan Speed |
| | | | Accelerated) |

A paper hold (not-shown) to hold roll paper 6a to be used is released out of paper roll 6 to be kept on the peripheral surface of platen 3 is mounted in the space opposing to said platen 3 in said housing 2. Further, an ink jet unit 27 reciprocating along said platen 3 in a direction parallel to the axis thereof is provided in the space opposing to said platen 3 in said housing 2. A carriage 27A of said ink jet unit 27 has thereon a plurality of ink jet heads (not-shown) which are directed against said platen 3. The position where said ink jet heads discharge ink toward the roll paper 6a held against the outer periphery of the platen 3 is designated as a printing portion PP (FIG. 2) to do the printing against the roll paper 6a.

A driving belt 28 is connected to said ink jet unit 27, and said driving belt 28 is wound about a driving pulley 30 which is driven by a second motor 29 of reversible type. Accordingly, when driving said second motor 29, said ink jet unit 27 is reciprocated along said platen 3 under the guidance of a guide shaft 31 located in parallel to said platen 3. A pump unit 32 for covering the nozzles of restrictive ink jet heads of said ink jet unit 27 for the purpose of recovering operation thereof is located on one side of the other end portion of said platen 3, and an exhaust liquid tank 33 is provided adjacent to said pump unit 32.

Photointerrupters 34 of transmission type are located with a distance therebetween in the front and back direction of said carriage 27A on the bottom side of said carriage 27A of said ink jet unit 27, and a linear encoder 35 comprising a thin plate having therein a number of small holes corresponding to printing resolution is located along the whole range of shifting ink jet unit 27.

A detection unit 36 for detecting roll paper 6a on said platen 3 is located on the upstream side of said ink jet unit 27 in the normal conveying direction of said roll paper 6a so as to oppose said platen 3. Said roll paper presence/absence detection unit 36 has photosensors 37 to emit a light from the light emitting portion toward the outer periphery of the platen 3. The thus emitted light is reflected by the roll paper 6a positioned on the platen 3 such that the intensity of the reflected light is converted into an electrical signal by the light receiving portion to be sent to the control means 22 which will be explained later.

Cutting unit 40 consisting of long sized fixed blade 38 and movable blade 39 for cutting printed roll paper 6a is located below said platen 3 and ink jet unit 27.

Said paper detection unit 41 for detecting roll paper 6a is located between said-printing portion PP and said cutting portion CP. The detection unit 41 of the paper leading end is for determining whether or not the reverse feed amount of the roll paper 6a is adequate at such a time as the cut roll paper 6a to be subjected to printing is fed backwardly of the regular feed direction. When a lever switch not shown detects the leading end (cut end) of the roll paper 6a, a detect signal is emitted to the control means 22 which will be explained later. Then, said control means 22 stops driving the first motor 4 which is feeding the roll paper 6a backwardly.

Each driving portion such as said both paper detection units 11, 36, 41 and said both motors 4, 29 and ink jet unit 27 is respectively connected to a control means 22, so that when signals about roll paper 6a from said paper detection units 11, 36, 41 are input into said control means 22, this control means 22 controls said respective motor 4, 29 and ink jet unit 27 correspondingly to the input signals.

As shown further in FIG. 2, the upper opening (not-shown) of said housing 2 is covered by a closing cover 2A.

FIG. 7 shows a control block diagram of printing device including said control means 22.

As shown in FIG. 7, said control means 22 consists of a mother board 42 having a control panel (not-shown); a CPU board 26, a mechanical control board 43 and a head control board 44 connected to each other via said mother board 42.

Said mother board 42 is connected to a paper detection unit 11 for detecting the type of roll paper 6a used, a paper presence/absence detection unit 36 for detecting the presence or absence of said roll paper, a paper leading end detection unit 41 for detecting the leading end of said roll paper, said pump unit 32; said exhaust liquid tank 33; a CR unit 45 for driving said second motor 29 shifting said ink jet unit 27; a LF unit 46 for driving said first motor 4 conveying said roll paper 6a.

Said CPU board 26 has built-in CPU, ROM, RAM and the like, among which ROM has programs for operation and graphic processing, and carrying out printing based on corresponding detection result, such as type of paper, presence or absence of paper, leading end of paper by detecting signals provided by each detection unit 11, 36 and 41.

Said mechanical control board 43 includes drivers (not-shown) for driving said detection units 11,36 and 41, pump unit 32, CR unit 45 and LF unit 46. Further, said mechanical control board 43 can transfer signals to said CPU of said CPU board 26.

Said head control board 44 has ink detection board 47 and head drive board 48, and transfers a detection signal of residual ink quantity detected by said ink detection board 47 located on said ink jet unit 27 to said CPU of said CPU board 26, and, in said head drive board 48, said head control board 44 also transfers logical signals based on information from said CPU for driving said ink jet unit 27. Based on said logical signals, said head drive board 48 generates driving signals for driving respective ink jet head 49 and respective ink cartridge 50.

Further, in said CR unit 45, said linear encoder 35 is connected in parallel to said second motor 29, said linear encoder 35 outputting to said CPU of said CPU board 26 signals correspondingly to rotational sped of said second motor 29 for equalizing the shifting speed of said ink jet unit 27.

Further, said mother board 42 is provided with interface unit 51, 52 for connecting this printing device 1 to personal computer and the like.

Further, the program stored in said CPU board 26 determines the presence of the paper upon detection of an intense reflection and outputting an electrical signal HIGH by the photosensor 37 of the detection unit 36 of paper presence/absence when the paper (roll paper 6a) detected by the detection unit 11 of paper type is opaque. On the other hand, if the paper detected by the detection unit 11 of the paper type is transparent, most of the light emitted by the light sensor 36 of the detection unit 36 of the paper presence/absence permeates the paper to be absorbed by the surface of the platen such that the photosensor 37 of the detection unit 36 of the paper presence/absence will not detect the reflection and emits an electrical signal LOW to determine the presence of the paper.

In other words, the control means 22 is constructed to perform a reverse determination concerning the information from the photosensor 37 of the detection unit 36 of paper presence/absence based on the result obtained by the detection unit 11 of the paper type as to whether the paper 6a is of light transmitting nature or not.

Next, the operation flow of said printing device 1 will be explained hereinafter.

First, cover 2A is opened for mounting a paper roll 6 including a desired type of roll paper 6a onto roll holding mechanism 8. Wire 19 connected to this cover 2A is thus pulled in the direction B against the urging force of coil spring 18, so that sliding table 15 connected to this wire 19 is also pulled in the same direction B and flange abutting member 17 is retracted into a retraction place so as not to impede inserting operation of paper roll 6. In this state of mechanism, holders 6b having each flange 6c of outer diameter adapted to that of roll paper 6a mount paper roll 6 on both roll holders 9A, 9B of roll holding mechanism 8.

Then, upon closing of cover 2A, wire 19 is relaxed, sliding table 15 shifts in the direction A under the urging force of coil spring 18, and abutting surface 17a of flange abutting member 17 is urged onto peripheral surface of flange 6c. Correspondingly to the position of thus stopped sliding table 15, three photosensors 21 are respectively ON state or OFF state, so that type of paper is detected as shown in Table 1. This information is output from output connector 23 to said CPU board 26 which detects type of paper based on Table 1 and can indicate predetermined image processing and head driving corresponding to detected type of paper.

Upon switching printing device power supply into ON, CPU of CPU board 26 initializes respective parts 26, 43, 44, 47, 48 and respective units 27, 32, 45, 46 and respective detection mechanism 11, 36, 41 and then recognizes type of paper used, presence or absence of paper on the printing portion PP, position of leading end of paper, by means of signals from paper detection unit, paper presence/absence detection unit and paper leading end detection unit, respectively. In this situation, the recognition of the paper by means of the photosensor of the detection unit 36 of the paper presence/absence for the control means 22 is constructed to perform a determination by reversing the information from the photosensor 37 of the detection unit 36 of the paper presence/absence on the basis of the result as to whether the paper is light transmitting or not.

In other words, in case where the detection result as to the type of the roll paper 6a by means of the detection unit 11 of the paper type is that the paper is an ordinary opaque paper which will not allow a light to permeate therethrough, the photosensor 37 of the detection unit 36 of paper presence/absence detects an intense reflection by the surface of the roll paper 6a to emit an electrical signal HIGH for the control means 22 to provide a determination of “paper present” when the roll paper 6a is on the platen 3 whereas the light emitted by the photosensor 37 is directly irradiated onto the surface of the platen 3 to be absorbed by its surface such that the photosensor 37 will not detect the reflected light and emits an electrical signal LOW for the control means 22 to provide a determination of “paper absent”.

On the other hand, in case where the detection result as the type of the roll paper 6a by means of the detection unit 11 of the paper type is that the paper is formed of a transparent sheet 12 of light transmitting paper such as a paper for the over head projector, the photosensor 37 will not detect the reflected light because most of the light irradiated by the photosensor 36 of the detection unit 36 of paper presence/absence permeates the paper directly onto the surface of the platen 3 to be absorbed thereby when the roll paper 6a is positioned on the platen 3. In such situation, the photosensor emits an electrical signal LOW such that the control means 22 provides a determination of “paper present”. When the trailing end of the roll paper 6a is positioned on the platen 3 after the printing has been done on the roll paper 6a, the photosensor detects an intense reflection from the light reflecting portion 12a formed of a transparent sheet and positioned at the trailing end of the roll paper 6a on the platen and outputs an electrical signal HIGH such that the control means 22 provides a determination of “paper absent”.

In other words, the control means 22 is constructed to perform a determination by reversing the output (information) from the photosensor 37 based on the result obtained by the detection unit 11 of the paper type as to whether the roll paper 6a is of light transmitting nature or not.

In this connection, the roll paper 6a is cut off at its trailing end by the paper cutting unit 40 after the printing action to form a separate sheet of paper which is discharged to complete the printing operation. When the printing operation of a sheet of paper is finished, it is needed for performing the next printing action to rewind the roll paper 6a by a predetermined distance by the first motor 4 because the distance from the printing portion PP to the cutting portion CP is larger than the margin formed at the leading end of the paper at the time of an ordinary printing action. The amount of reverse feed of the roll paper 6a is sufficiently compensated for by feeding the roll paper 6a backwardly a constant amount if the leading end of the roll paper 6a is always positioned at the cutting portion CP. Actually, however, the position of the leading end of the roll paper 6a varies depending on situations so that the amount of reverse feed of the roll paper 6a is determined by the result of detection of the leading end of the roll paper 6a by means of detection unit 41 of the paper leading end. In other words, the control means 22 controls the amount of reverse feed for the roll paper 6a by driving the second motor 29 until the detection unit 41 of the leading end of the paper detects the leading end of the roll paper after the roll paper 6a is cut off at its trailing end by the paper cutting mechanism 40 such that position of the leading end of the roll paper 6a for the printing action is done at a position suitable for printing.

From the information about ink type stored in a nonvolatile memory in head control board 44, said CPU receives signals for recognizing ink type. By using the data of detected type and type of ink and/or paper, said CPU looks up data table written in ROM of said CPU board 26, thereby to set the procedure of the printing data and to set servo constant to determine the printing speed.

In this way, the printing is done in accordance with the type of ink and paper.

In this embodiment of the invention, since type of paper can be automatically detected upon mounting of said paper roll 6 onto roll holder 9A, 9B as described above, double printing and/or inferior image quality due to input error of paper type by operator can be prevented. Further, since paper used is automatically detected according to outer diameter of flanges 6c, more various types of paper can be handled by increasing the number of sensors. Further, since flange abutting member 17 is retracted when exchanging paper roll 6, flange abutting member 17 does not impede the exchange of paper roll 6.

Further, said detection unit 11 of the paper type is capable of automatically detecting the paper type from the position of the flange abutting member 17 abutting against said flange 6c merely by attaching a flange 6c to the paper roll 6, said flange having an outer diameter corresponding to the type of the roll paper 6a. Said detection unit 36 of the paper presence/absence is capable of automatically detecting the presence/absence of the roll paper 6a without contact. Said detection unit 41 of the paper leading end is capable of automatically detecting the leading end of the roll paper 6a subjected to printing to determine whether said leading end is properly positioned or not. Said control means 22 is capable of controlling the relevant portions such that a proper printing action onto the roll paper is assured on the basis of the detection result of the respective detection units 11, 36 and 41 and capable of automatically detecting the presence/absence of the roll paper to be positioned at the printing portion PP by means of the photosensors 37, regardless of whether the roll paper 6a is of light transmitting nature or not.

The relationship between the detection result by said respective detection units 11, 36 and 41 and the printing action of the control means 22 based on the detection result is shown in Table 3 below.

TABLE 3

| Detection Unit | Detection Unit | Detection Unit | |
|---|---|---|---|
| of | of Paper | of Paper | Control |
| Paper Type | Presence/Absence | Leading End | Means |
| 11 | 36 | 41 | 22 |
| Paper: | Light Reflection: | Paper: | Printing Action: |
| Present | Absent | Present | Suspended |
| Transparent | | | |
| Paper: | Light Transmission: | Paper: | Printing Action: |
| Present | Present | Present | Possible |
| Transparent | | | |
| Paper: | Light Reflection: | Paper: | printing Action: |
| Present | Present | Present | Possible |
| Opaque | | | |
| Paper: | Light Transmission: | Paper: | Printing Action: |
| Present | Absent | Present | Suspended |
| Opaque | | | |

Now, said detection unit 11 of paper type is adapted to output a signal indicating “paper absent” when the paper roll 6 is not loaded to the paper roll holding mechanism 8 while the control means 22 makes the printing action impossible.

Further, the roll paper 6a is formed of a transparent sheet which is light transmitting, with the trailing end of said transparent sheet 12 being formed with a light reflecting portion 12a. Therefore, it is possible to effectively use the entire surface of the roll paper 6a even if the roll sheet formed of the transparent sheet 12 of light transmitting nature is used. Moreover, the light reflecting portion 12a of the roll paper 6a makes it possible for the photosensors 37 in the detection unit 36 of paper presence/absence to automatically detect the trailing end of the roll paper 6a.

The present invention is not limited to the above described embodiments but can be modified if necessary.

As explained in the foregoing, the present invention is characterized in that the detection unit of paper type is capable of automatically detecting the paper type on the basis of the position of the flange abutting member which abuts against the flange merely if the flange having an outer diameter corresponding to the type of the roll paper is attached to the paper roll, that the detection unit of paper presence/absence is capable of automatically detect the presence/absence of the paper without contact thereto, that the detection unit of the paper leading end is capable of automatically detecting the paper leading end to determine whether said leading end is properly positioned, and that the control means is capable of controlling the relevant portions to perform the proper printing actions on the basis of the detection result of the respective detection units.

Further, the roll paper according to the present invention makes it possible to effectively use the entire surface of the roll paper when the roll paper formed of the transparent sheet of light transmitting nature is used and to automatically detect the trailing end of the roll paper in the detection unit of paper presence/absence by means of the light reflecting portions of the roll paper.

What is claimed is:

1. A printing device in which a paper roll is supported in a paper roll holding mechanism by way of holders attached at the opposite ends of said paper roll, each holder being formed with a flange, roll paper being payed out from said paper roll such that printing is performed on said payed-out roll paper by means of a platen and printing heads, said printed paper roll being cut off by a paper cut mechanism,
said printing device comprising a movable flange abutting member adapted to be pressed against an outer periphery of said flange of the holder of the paper roll held in said paper roll holding mechanism, said flange having an outer diameter set in correspondence with the type of said roll paper; a detection unit of paper type adapted to be subjected to positioning by said outer periphery of the flange for detecting said type of the roll paper; a detection unit of paper presence/absence provided at a printing portion in facing relation to said platen to detect the presence/absence of said roll paper without contact therewith; a detection unit for detecting the leading end of said roll paper arranged between said printing portion and a cutting portion to be subjected to a printing operation; and a control means for controlling actions of the relevant portions on the basis of the detection result of each detection mechanism.

2. A printing device according to claim 1, wherein said detection unit of paper presence/absence is composed of a photosensor, said control means being constructed to determine the paper type by reversing information from the photosensor on the basis of a detection result whether said roll paper is of a light transmitting nature or not.

3. A roll paper composed of a transparent sheet of a light transmitting nature, in which a light reflecting portion is formed at the trailing end thereof.
